(19) United States
(12) Patent Application Publication
(10) Pub. No.: US 2024/0170746 A1
(43) Pub. Date: May 23, 2024

(54) BATTERY CONTROL AND ANALYSIS

(71) Applicant: Constellation Energy Generation, LLC, Kennett Square, PA (US)

(72) Inventors: Alexandre LeBlanc, Waterloo (CA); Justin Robert Smith, Bettendorf, IA (US)

(21) Appl. No.: 18/301,698

(22) Filed: Apr. 17, 2023

Related U.S. Application Data
(60) Provisional application No. 63/427,615, filed on Nov. 23, 2022.

(51) Int. Cl. H01M 10/48; G01K 7/25; H01M 10/42; H02J 7/00

(52) U.S. Cl. CPC H01M 10/486; G01K 7/25; H01M 10/4257; H02J 7/0031; H01M 2010/4271; H01M 2200/10

(57) ABSTRACT

A system includes a battery assembly. The system includes a circuit board comprising circuitry. The circuitry includes a first trace. The system includes an integrated circuit mounted on the circuit board. The integrated circuit includes a thermistor pin. The thermistor pin is configured to initiate a first mode of the integrated circuit. The integrated circuit is configured to monitor cells of the battery assembly. The system includes a first switch mounted on the circuit board. The first switch includes a first position and a second position. The first position is configured conduct and the second position configured to impede. The circuitry is configured to change a voltage of the thermistor pin based on the first trace according to the first switch.

### CROSS-REFERENCE TO RELATED APPLICATIONS

This application claims the benefit of U.S. Provisional Application No. 63/427,615, filed Nov. 23, 2022, which is incorporated herein in its entirety.

### BACKGROUND

Batteries and energy storage devices provide electricity for various devices. Batteries and energy storage devices can experience failures and other issues. For example, individual cells of the battery may charge or discharge at different rates, leading to early cell failure. Short circuits may lead to high discharge currents or high temperature failures. These and other constraints may require limitations on output current from an entire battery system or alter the shape and size of batteries.

### SUMMARY

It is to be understood that both the following general description and the following detailed description are exemplary and explanatory only and are not restrictive. Methods, apparatuses, and systems for battery control and analysis are described.

A system may include a battery assembly. The system may include a circuit board comprising circuitry. The circuitry may include a first trace. The system may include an integrated circuit mounted on the circuit board. The integrated circuit may include a thermistor pin. The thermistor pin may be configured to initiate a first mode of the integrated circuit. The integrated circuit may be configured to monitor cells of the battery assembly. The system may include a first switch mounted on the circuit board. The first switch may include a first position and a second position. The first position may be configured to conduct and the second position configured to impede. The circuitry may be configured to change a voltage of the thermistor pin based on the first trace according to the first switch.

A system may include a first transistor. The system may include a second transistor. The system may include a circuit board fabricated to form a first planar surface. The circuit board may include a first trace and a second trace. The system may include an integrated circuit mounted on the circuit board. The integrated circuit may be configured to control the first transistor with the first trace. The integrated circuit may be configured to control the second transistor with the second trace. The system may include a first conductor fabricated to form a second planar surface. The second planar surface may be offset from the first planar surface and the second planar surface may be parallel to the first planar surface. The first conductor may be configured to conduct electricity between a first terminal of the first transistor and a second terminal of the second transistor.

A system may include a battery assembly and the battery assembly may include one or more battery cells. The system may include an integrated circuit configured to output a regulated voltage. The output of the regulated voltage may be based on the battery assembly. The system may include a voltage converter. The voltage converter may include a first input. The first input may be configured to receive a first input voltage. The voltage converter may include a field effect transistor. The voltage converter may include a converted voltage. The voltage convert may be configured to output based on the first input and the field effect transistor. The voltage converter may include a second input. The second input may be configured to receive a second input voltage based on the regulated voltage. The second input may be configured to disable the output based on the second input voltage.

### BRIEF DESCRIPTION OF THE DRAWINGS

In order to provide understanding techniques described, the figures provide non-limiting examples in accordance with one or more implementations of the present disclosure, in which:

FIG. 1 shows an example battery manager in accordance with one or more implementations of the present disclosure;

FIG. 2 shows example circuitry in accordance with one or more implementations of the present disclosure;

FIG. 3 shows example circuitry in accordance with one or more implementations of the present disclosure;

FIG. 4 shows an example circuit board and conductors in accordance with one or more implementations of the present disclosure;

FIG. 5 shows an example configuration in accordance with one or more implementations of the present disclosure;

FIG. 6 shows an example side view in accordance with one or more implementations of the present disclosure;

FIG. 7 shows an example side view in accordance with one or more implementations of the present disclosure;

FIG. 8 shows example circuitry in accordance with one or more implementations of the present disclosure;

FIG. 9 shows example circuitry in accordance with one or more implementations of the present disclosure; and

FIG. 10 shows example system in accordance with one or more implementations of the present disclosure;

FIG. 11 shows a flowchart of an example method in accordance with one or more implementations of the present disclosure; and

FIG. 12 shows a flowchart of an example method in accordance with one or more implementations of the present disclosure.

### DETAILED DESCRIPTION

As used in the specification and the appended claims, the singular forms “a,” “an,” and “the” include plural referents unless the context clearly dictates otherwise. Ranges may be expressed herein as from “about” one particular value, and/or to “about” another particular value. When such a range is expressed, another configuration includes from the one particular value and/or to the other particular value. When values are expressed as approximations, by use of the antecedent “about,” it will be understood that the particular value forms another configuration. It will be further understood that the endpoints of each of the ranges are significant both in relation to the other endpoint, and independently of the other endpoint.

It is understood that when combinations, subsets, interactions, groups, etc. of components are described that, while specific reference of each various individual and collective combinations and permutations of these may not be explicitly described, each is specifically contemplated and described herein. This applies to all parts of this application including, but not limited to, steps in described methods. Thus, if there are a variety of additional steps that may be performed it is understood that each of these additional steps may be performed with any specific configuration or combination of configurations of the described methods.

As will be appreciated by one skilled in the art, hardware, software, or a combination of software and hardware may be implemented. Furthermore, the methods and systems may take the form of a computer program product on a computer-readable storage medium (non-transitory) having processor-executable instructions (e.g., computer software) embodied in the storage medium. Any suitable computer-readable storage medium may be utilized including hard disks, CD-ROMs, optical storage devices, magnetic storage devices, memresistors, Non-Volatile Random Access Memory (NVRAM), flash memory, or a combination thereof.

Throughout this application reference is made to block diagrams and flowcharts. It will be understood that each block of the block diagrams and flowcharts, and combinations of blocks in the block diagrams and flowcharts, respectively, may be implemented by processor-executable instructions. These processor-executable instructions may be loaded onto a computer (e.g., a special purpose computer), or other programmable data processing apparatus to produce a machine, such that the processor-executable instructions which execute on the computer or other programmable data processing apparatus create a device for implementing the functions specified in the flowchart block or blocks.

This detailed description may refer to a given entity performing some action. It should be understood that this language may in some cases mean that a system (e.g., a computer) owned and/or controlled by the given entity is actually performing the action.

Blocks of the block diagrams and flowcharts support combinations of devices for performing the specified functions, combinations of steps for performing the specified functions and program instruction means for performing the specified functions. It will also be understood that each block of the block diagrams and flowcharts, and combinations of blocks in the block diagrams and flowcharts, may be implemented by special purpose hardware-based computer systems that perform the specified functions or steps, or combinations of special purpose hardware and computer instructions.

The method steps recited throughout this disclosure may be combined, omitted, rearranged, or otherwise reorganized with any of the figures presented herein and are not intend to be limited to the four corners of each sheet presented.

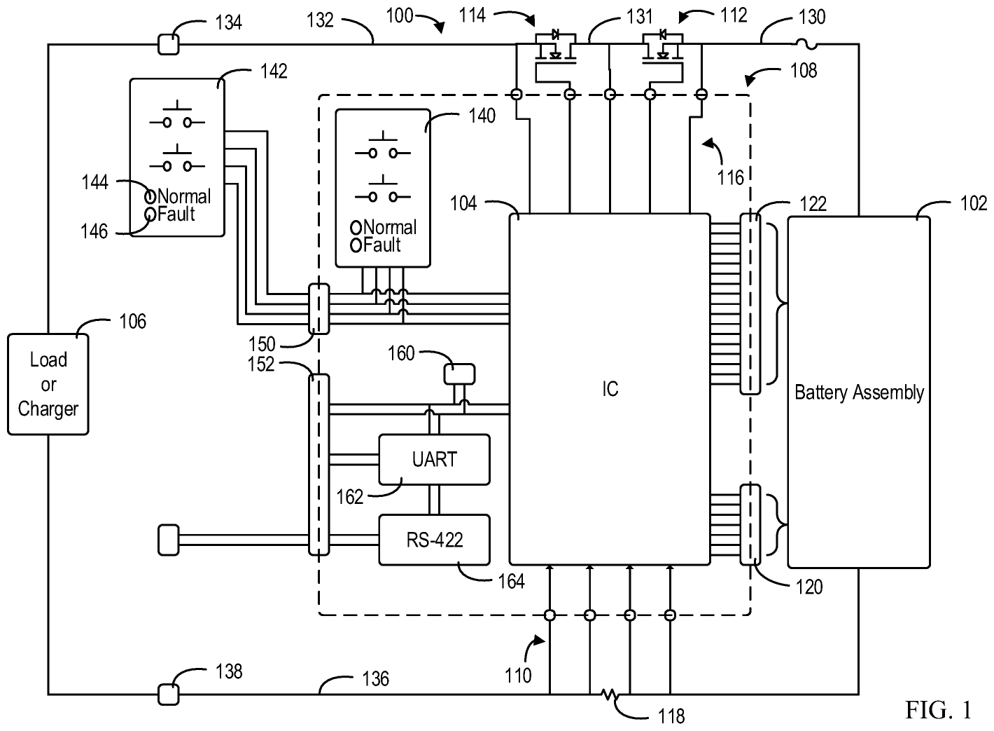

FIG. 1 shows an example battery manager 100 in accordance with one or more implementations of the present disclosure. A battery stack may include multiple battery assemblies 102. The battery assemblies 102 may include one or more cells. For example, the cells may be based on a Lithium Ion chemistry (e.g., LiFePO₄). Cells may be arranged in a stack (e.g., series, parallel) to produce a desired voltage or current output.

A battery manager 100 may be configured to manage one or more battery assemblies 102 to ensure that the cells maintain balanced voltages and temperatures. For example, the battery manager may include circuitry that connects to one or more of the cells and enables charging, monitoring, or a combination thereof. For example, the battery manager 100 may include individual connections 122 to the one or more cells. The cells may be connected in series. The battery manager 100 may include one or more integrated circuits 104 configured to monitor the battery assembly or control operation of the assembly. For example, the integrated circuit 104 may include input and output pins for monitoring, charging, and discharging the cells. The input and output pins may include a thermistor pin for measuring temperatures associated with the battery assembly. For example, circuitry may be included (e.g., thermistor connections 120) to monitor a temperature of the battery stack.

The battery manager 100 may be associated with transistors, or other switches, to control the flow of electricity between the battery assembly 102 and a load, a charger, or another battery assembly. For example, the battery assembly 102 may be daisy-chained, or arranged in series, with other battery assemblies due to the current throughput of the bus bars discussed herein. The bus bars may be arranged to keep currents off of the circuit board 108, allowing for higher currents than previously realized.

Further, the integrated circuit 104 may be associated with persistent programing, enabling operation without a microcontroller or processor. The integrated circuit 104 may be interacted with through a programming port 160. The programming port 160 may require a specific voltage, or voltage range, in order to enable programming. The voltage range may be different from a typical voltage range of the battery assembly. For example, the typical voltage range of the battery assembly 102 may be 150-200 Volts. The programming port may be enabled by application of a voltage of 10-12 Volts.

Integrated circuits (e.g., integrated circuit 104) may be designed for operation in combination with a microcontroller. For example, the microcontroller may be configured to control or monitor the integrated circuit 104 to ensure proper functionality and power consumption. For example, the microcontroller may send commands to the integrated circuit 104 to cause the circuit 104 to enter into one or more operating modes such as startup, wakeup, shutdown, sleep, and other operating modes. The microcontroller may also receive information from the integrated circuit 104 regarding the status of the battery assembly. For example, the microcontroller may receive state of charge or temperature information from the integrated circuit 104.

The combination of a microcontrollers and integrated circuits may introduce security vulnerabilities to the battery manager 100. For example, the microcontroller commands may be spoofed or intercepted to reprogram the integrated circuit 104 or change battery assembly control or monitoring. As such, the microcontroller may be removed to increase security and remove necessary functionality. For example, mode changes to the integrated circuit 104 may be unavailable without another interface for interacting with the integrated circuit 104.

The integrated circuit 104 may be disposed on a circuit board (e.g., circuit board 108). The circuit board may include connectors and interfaces for controlling and monitoring the battery assembly 102. For example, leads may connect the individual cells of the battery assembly to the circuit board and the integrated circuitry. Thermistors may be connected with the integrated circuit 104 through connectors. The connectors may be soldered together with traces on the circuit board that lead to the integrated circuit 104. Traces may be conductive elements etched into the circuit board 108 or other wiring associated with the circuit board 108.

The battery manager 100 may include a programming port 160. The programming port 160 may include an interface for programming the integrated circuit 104. For example, the programming port 160 may require a programming voltage (e.g., 10-12 Volts) different from the typical voltage of the battery assembly 102. The programming port 160 may be an I2C header.

A universal asynchronous receiver-transmitter (UART) converter 162 may be configured to interface with the integrated circuit 104. For example, the UART converter 162 may convert UART protocol communications to I2C protocol communications for communications off-board. For example, the UART converter 162 may be interconnected with an RS-422 converter 164 or another type of port for communications off-board. For example, the integrated circuit 104 may provide information related to battery state or battery health. For example, the information may be aggregated from multiple battery managers to determine battery performance or maintenance needs. The integrated circuit 104 may be in communication with one or more indicators (e.g., indicators 140, 142). The indicators 140, 142 may provide an indication of normal operation and fault conditions that are perceivable by an operator (e.g., illumination of light-emitting diodes 144, 146). The UART connector may be connected to specific pins so that the RS-422 converter 164 cannot be used to program the one-time programmable memory or change other registers or memory of the integrated circuit 104.

The integrated circuit 104 may be associated with circuitry that can control the charging and discharging of the battery assembly 102. For example, the integrated circuit 104 may be configured to operate elements 112, 114 configured to impede or allow the flow of electrons from the battery assembly 102. Elements 112, 114 may be transistors, switches, other implements, or combinations thereof. For example, elements 112, 114 may include a solenoid-operated switch. The elements 112, 114 may be field-effect transistors (FETs) or metal-oxide-semiconductor field-effect transistors (MOSFETs). Elements 112, 114 may be interconnected through conductors 130, 131, 132. For example, conductors 130, 131, 132 may be bus bars (e.g., solid or woven conductors). The conductors 130, 131, 132 may be formed from conductive materials (e.g., copper, silver, gold), alloys, or combinations thereof. For example, the conductors 130, 131, 132 may be connected with the circuit board through leads or traces 116. For example, the traces 116 may be configured to operate elements 112, 114 by control signals from the integrated circuit 104 to control the flow of electricity through the conductors 130, 131, 132.

The integrated circuit 104 may be associated with one or more resistors (e.g., resistor 118). Resistor 118 may be associated with conductor 136. For example, resistor 118 may be a necked or narrowed portion of the conductor 136. The resistor 118 may be associated with the integrated circuit 104 through leads or traces 110. The conductors 132, 136 may be attached to the load or charger 106 through couplings 134, 138. Communications from the circuit board 108 may be facilitated through connectors 150, 152. A voltage drop across the resistor or associated with the resistor may be measured for column counting. For example, discharge current from the battery assembly 102 may be monitored by measuring the voltage drop associated with resistor 118. Further, charge current to the battery assembly 102 may be monitored by measuring the voltage drop associated with resistor 118. In such a way, the integrated circuit 104 may be configured to monitor the state of charge, state of health, or other parameters associated with the battery assembly 102. In an example, the resistor 118 may be omitted.

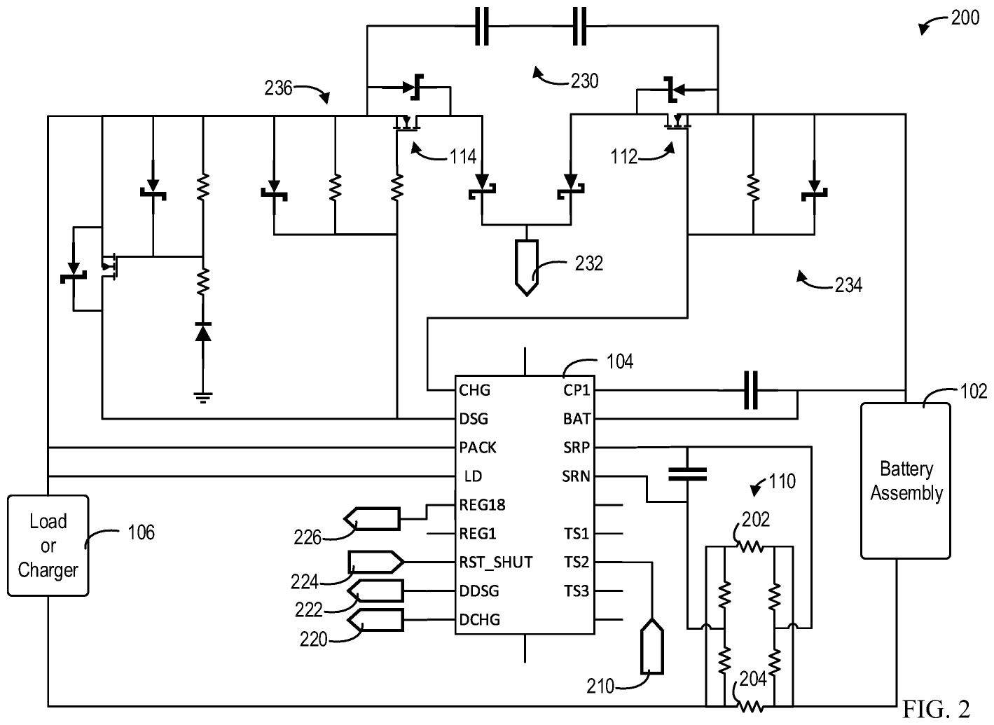

FIG. 2 shows an example circuitry 200 in accordance with one or more implementations of the present disclosure. The circuitry 200 may provide more detail into the operation of the discharge element 114 and the charge element 112. For example, the charge element 112 may be operated by a charge pin of the integrated circuit 104 and the associated trace or lead. For example, the trace may be connected with a gate of the charge element 112. In such a way, the charge element 112 may be configured to permit charging of the battery assembly 102.

The discharge element 114 may be operated by a discharge pin of the integrated circuit 104 and the associated trace or lead. For example, the trace may be connected with a gate of the discharge element 114. In such a way, the discharge element 112 may be configured to permit discharging of the battery assembly 102.

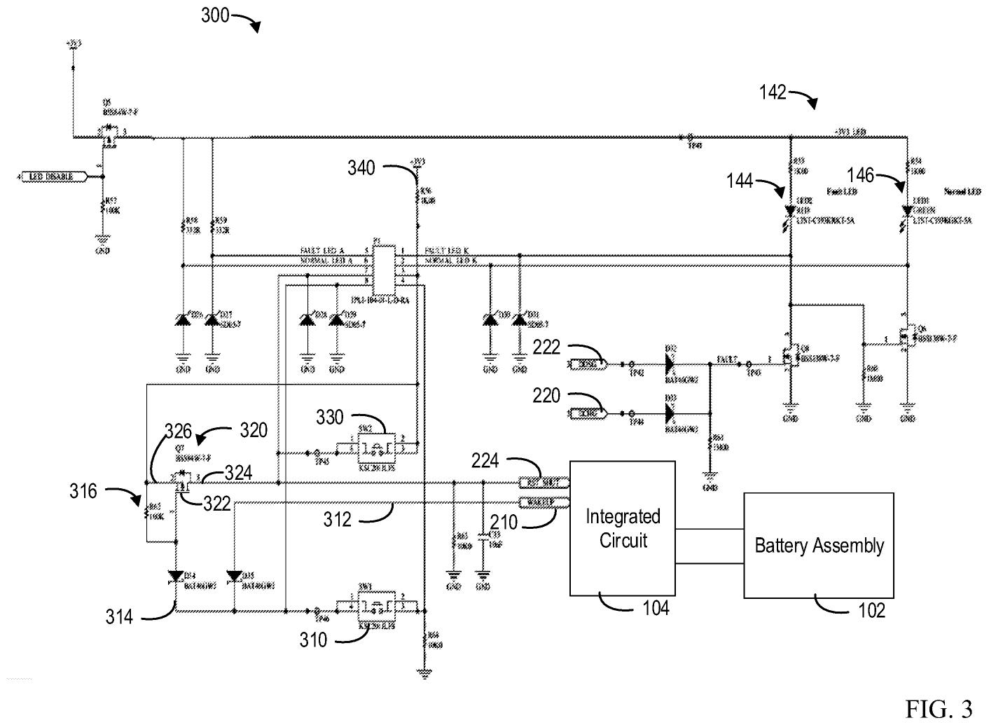

The integrated circuit 104 may be configured (e.g., programmed) to enable a regulated voltage 226. For example, the regulated voltage may be REG18 or a 1.8 V regulated voltage. The 1.8 V may be low-dropout regulated. The regulated voltage 226 may be provided on a pin or trace. The integrated circuit 104 may be configured to shutdown based on an applied voltage to the RST_SHUT pin 224. The DDSG pin 222 and DCHG pin 220 may be used to enable or disable one or more of the indicators 140, 142, as shown in FIG. 3. Further, the integrated circuit 104 may include a thermistor pin 210 configured to change power states of the integrated circuit 104, as shown in FIG. 3.

FIG. 3 shows an example circuitry in accordance with one or more implementations of the present disclosure. The integrated circuit 104 may include a shutdown pin 224. For example, the shutdown pin 224 may be tied to logic of the integrated circuit 104 to enter sleep, shutdown, or other modes with reduced power consumption. The integrated circuit 104 may include a thermistor pin 210. The thermistor pin 210 may be configured to receive signals from one or more thermistors associated with the battery assembly 102. The thermistor pin 210 may be tied to logic of the integrated circuit 104 to wakeup from sleep, shutdown, or other power modes and return to a mode with a higher power consumption (e.g., normal operating mode). The integrated circuit 104 may include a reference voltage (e.g., REG18 or REG1). The reference voltage may be set by a register of the integrated circuit 104, which may be programmed according to port 160. For example, the reference voltage may be indicated by one-time programmable memory associated with the integrated circuit 104. The reference voltage may be regulated to the voltage indicated in the register or one-time programmable memory.

Circuitry may be mounted or included with the circuit board to interact with the shutdown pin 224 and the thermistor pin 210. For example, a switch 310 may be mounted on the circuit board. The switch 310 may be a push button switch. For example, the switch 310 may be configured to be normally open or normally impede current from traversing the switch 310 elements. The switch 310 may include two positions. For example, a user may push the switch 310 into a first position allowing conduction of electricity and the user may release the switch 310 into a second position preventing conduction of electricity.

The switch 310 may be configured to complete a circuit between the thermistor pin 210 and a ground connection through a trace (e.g., trace 312). For example, the switch 310 may be configured to drive the thermistor pin 210 to ground. The thermistor pin 210 may be set to a predetermined voltage when the integrated circuit 104 is in the shutdown or sleep mode. The predetermined voltage may be a digitally HIGH voltage. The switch 310 may drop the digitally HIGH voltage to a digitally LOW voltage or drop the voltage below a threshold indicative to the integrated circuit 104 to wakeup or move out of the sleep or shutdown modes.

A transistor 320 may be mounted on the circuit board. For example, the transistor 320 may be a p-channel enhancement MOSFET. The transistor 320 may be included with circuitry that makes a conductive connection between the regulated reference voltage 340 and a source terminal 326 of the transistor 320. The transistor 320 may further include a drain terminal 324. A conductive connection may be formed between the drain terminal 324 of the transistor 320 and the shutdown pin 224. For example, a trace may be etched in the circuit board to form the conductive connection. The transistor 320 may include a gate terminal 322. A conductive connection may be formed through a trace 314 with the switch 310. For example, the switch 310 may be configured to pull the gate terminal 322 of the transistor 320 to ground.

The transistor 320 may be associated with a resistive component 316. The resistive component 316 may provide a preconfigured resistance (e.g., 3001d1). The resistive component 316 may be disposed between the source terminal 326 and the gate terminal 322. As such, the reference voltage may be present at the source terminal 326. As the switch 310 is closed, the gate terminal 322 may be set to ground and the voltage between the gate terminal 322 and the source terminal 326 may exceed a threshold to allow the MOSFET to conduct based on the voltage drop over the resistor. For example, the switch 310 may cause current to flow across the transistor 320 such that a voltage at the shutdown pin 224 is based on the regulated reference voltage 340.

One or more of the shutdown pins 224 and the thermistor pin 210 may be associated with a predetermined duration. If the shutdown pin 224 exceeds the regulated reference voltage 340 for more than the predetermined duration, the integrated circuit 104 may enter the shutdown mode. The thermistor pin 210 may initiate a wakeup of the integrated circuit 104 as soon as the voltage of the thermistor pin 210 is pulled to ground. As such, one switch may enable shutdown of the integrated circuit 104 and wakeup of the integrated circuit 104. For example, a long press (e.g., longer than the predetermined duration) of the switch 310 may initiate shutdown of the integrated circuit 104, and a short press (e.g., shorter than the predetermined duration) may initiate wakeup of the integrated circuit 104. A second switch 330 may be used to directly tie the regulated reference voltage 340 to the shutdown pin 224 to provide additional flexibility in initiating shutdown of the integrated circuit 104.

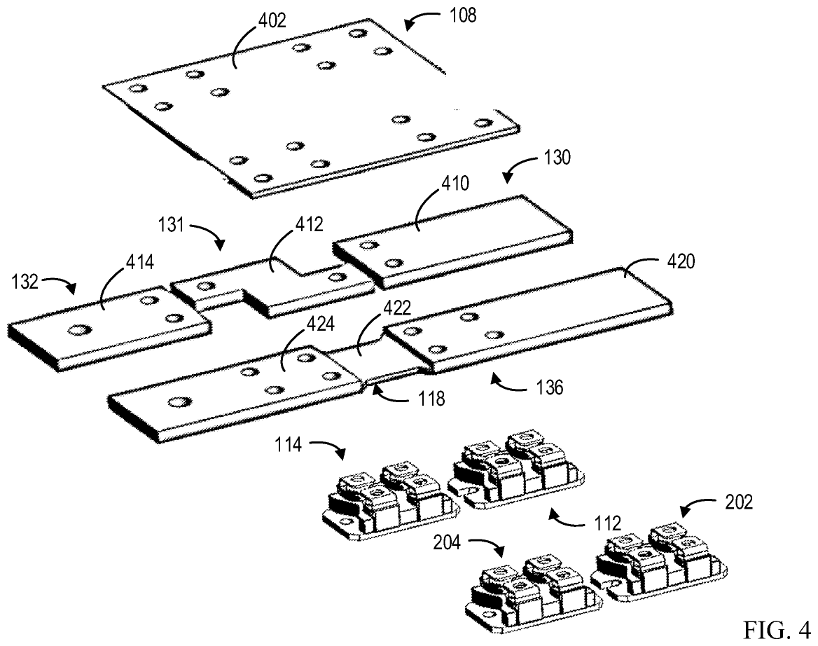

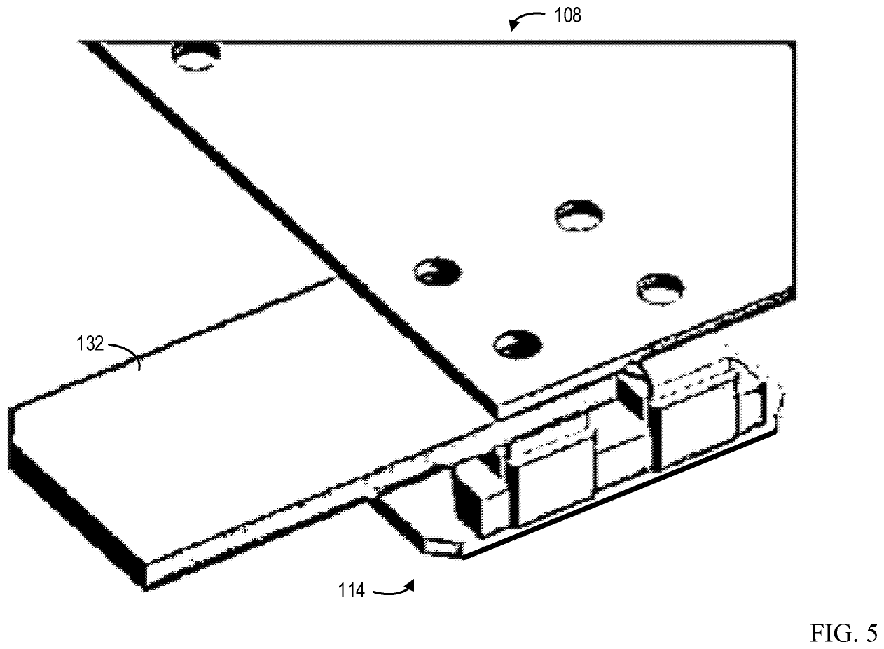

FIGS. 4-5 show an example circuit board 108 and conductors 130, 131, 132, 136 in accordance with one or more implementations of the present disclosure. The circuit board 108 may form one or more planar surfaces (e.g., planar surface 402). The circuit board 108 may define holes or other openings for receiving a fastener. The conductors 130, 131, 132, 136 may be distinct or individual components. One or more of the conductors 130, 131, 132, 136 may be unitary. For example, the conductors 130, 131, 132 may be a unitary piece, joined by an insulator. The conductors 130, 131, 132 may form respective planar surfaces (e.g., planar surfaces 410, 412, 414). The conductor 136 may further form one or more planar surfaces 420, 422, 424.

Conductor 131 may include one or more non-linear portions to connect the drain terminals of elements 112, 114. For example, the non-linear portions may include right angles (e.g., 90°). Conductor 131 may comprise an elbow, zig-zag, or bend. For example, conductor 131 may include one or more (e.g., two) non-linear or angled portions having angles between 90° and 180°. The non-linear or angled portions may have equivalent angles and opposite angles such that a first portion of the conductor 131 and a second portion of the conductor 131 are parallel, as shown in FIG. 4, and a middle portion of the conductor 131 maintains continuity of conduction between the first portion of the conductor 131 and the second portion of the conductor.

Conductor 136 may include a necked or narrowed portion, resisting the flow of electrons over the conductor 136 (e.g., acting as a resistor 118). The necked portion may be machined. The necked portion may be between holes for fastening additional resistors (e.g., resistors 202, 204). The resistors 202, 204 may have a similar form factor to the elements 112, 114 (e.g., transistors). For example, the resistors 202, 204 may have the same, or similar, thicknesses as elements 112, 114. The resistors 202, 204 and elements 112, 114 may be fastened or secured to the battery assembly 102, the circuit board 108, and the conductors 130, 131, 132, 136. As such, the battery assembly 102, resistors 202, 204, elements 112, 114, circuit board 108, and conductors 130, 131, 132, 136 may each include one or more planar surfaces that are situated in parallel. Resistors 202, 204 may be arranged in a bridge, and resistor 118 may be omitted.

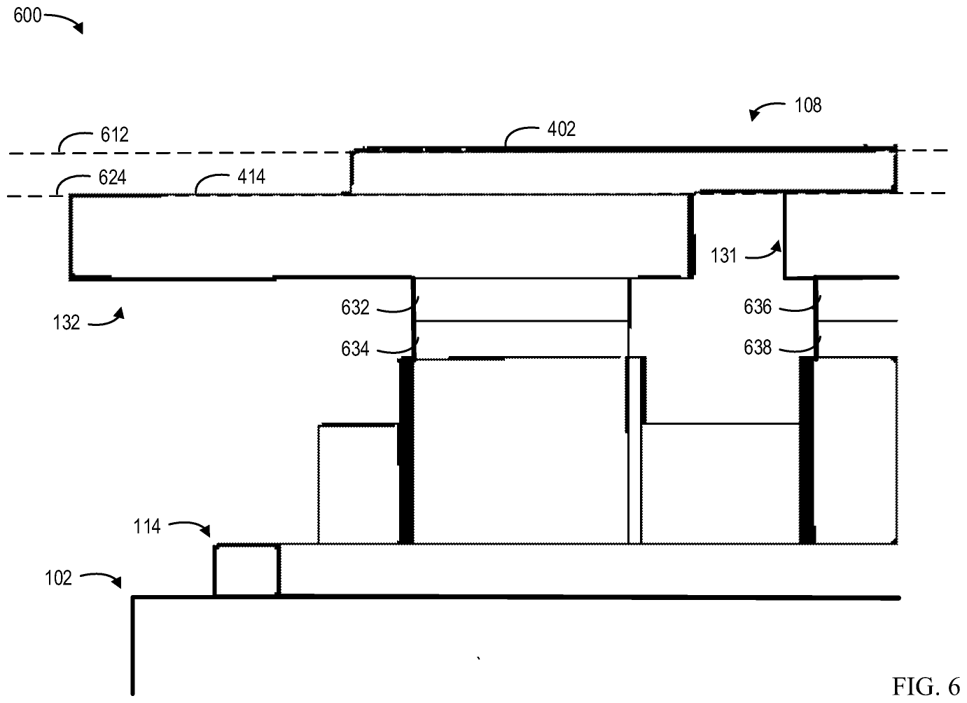

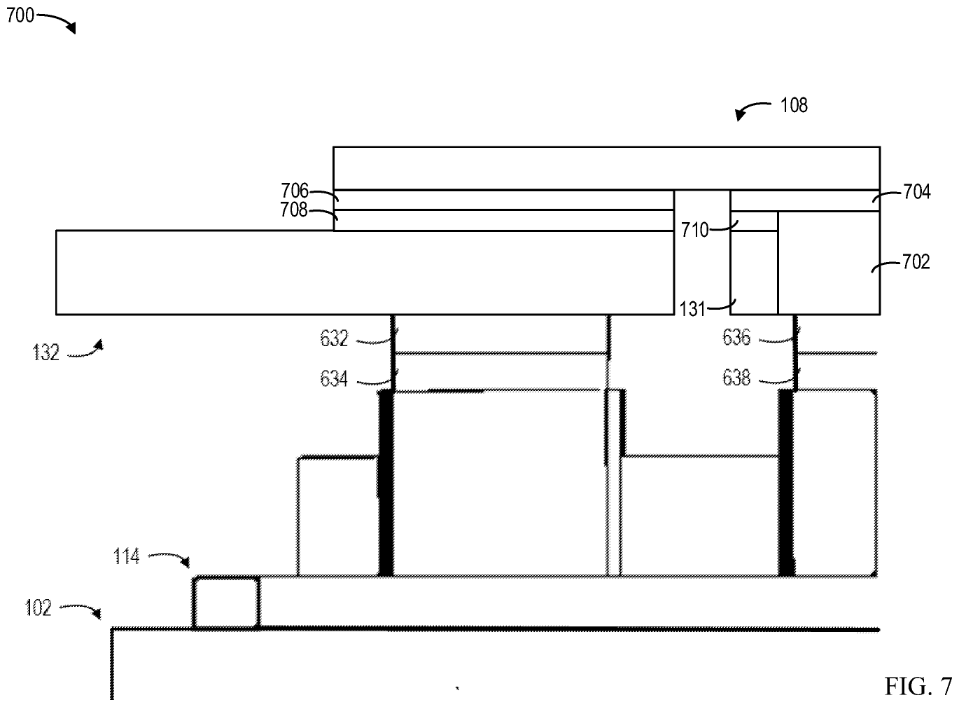

FIGS. 6-7 show example side views in accordance with one or more implementations of the present disclosure. The side views are indicative of a thickness of the components shown (e.g., conductors 130, 131, 132, 136). For example, the planar surfaces 402, 414 are shown from a different aspect than as shown in FIG. 4. As shown in FIGS. 6-7, the planar surfaces 402, 414 may be offset and substantially parallel as indicated by parallel lines 612, 624 extending from the planar surfaces 402, 414. Element 114 and the battery assembly 102 may have respective planar surfaces in parallel with parallel lines 612, 624. Element 114 may be fasted to one or more of the circuit board 108, conductors 132, 131, or battery assembly 102. Element 114 may include fastener receivers 632, 634, 636, 638 (e.g., internally threaded receptacles) for receiving a fastener through one or more of the circuit board 108 or conductors 132, 131 through defined holes or openings.

The conductors 130, 131, 132, 136 may include internal resistances and other characteristics that may generate heat (e.g., Joule heating). Conductive layers 704, 706 may be situated between the circuit board 108 and the conductors 131, 132. Material for the conductive layers 704, 706 may be selected to have a high thermal conductivity and a low electrical conductivity. The conductive layers 704, 706 may be connected with a heatsink. The conductive layers 704, 706 may have a surface area that mimics a cross-sectional area of the related conductor (e.g., conductor 131 and conductive layer 704). For example, conductor 131 may be situated underneath the circuit board 108 when installed with the battery assembly 102. The conductive layer 704 may have a surface area that is equal to or greater than the surface area of a surface of the conductor 131 that may be facing or opposed to the circuit board 108.

The conductive layers 704, 706 may be spaced from the conductors 130, 131, 132, 136 with spacers 702, 708, 710. For example, the spacers 702, 708, 710 may be insulators (e.g., thermal, electrical). The spacers 702, 708, 710 may be sized to maintain parallel planar surfaces of the circuit board 108, the conductors 130, 131, 132, 136, the elements 112, 114, the battery assembly 102, or otherwise. For example, element 114 may include four fastener receptacles and the conductors 131, 132 may be only situated on three of the fastener receptacles. As such, the spacer 702 may be sized with a thickness of spacers 708, 710 and the thickness of one or more of the conductors 131, 132.

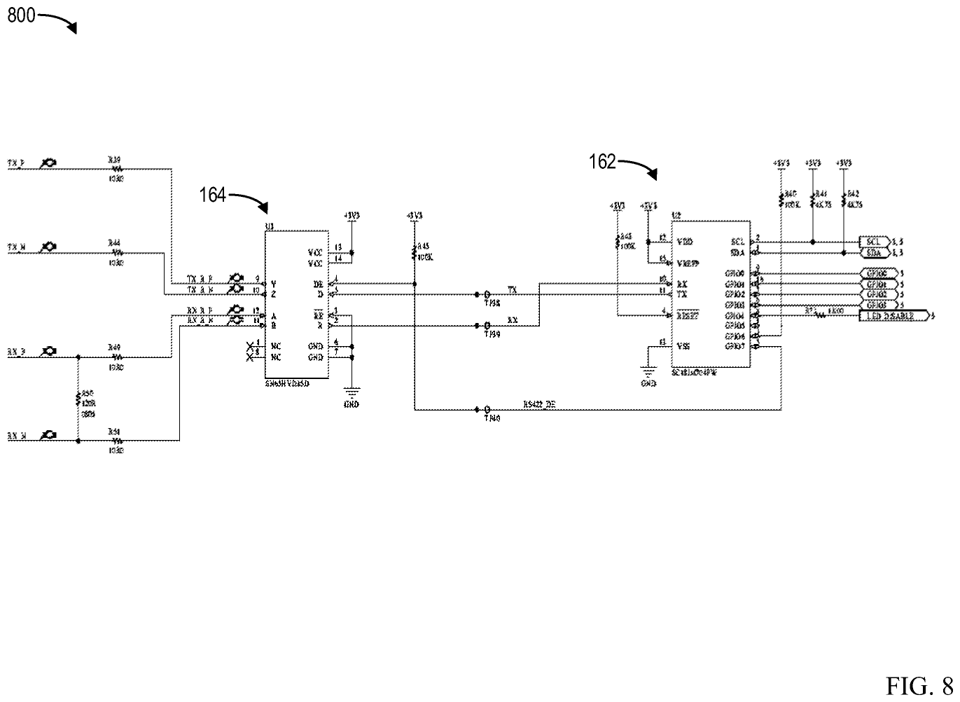

FIG. 8 shows example circuitry 800 in accordance with one or more implementations of the present disclosure. For example, the circuitry 800 may be configured to communicate with a data aggregator off-board (e.g., off of the circuit board 108). The circuitry 800 may include a UART converter 162 configured to interface with the integrated circuit 104. For example, the UART converter 162 may convert UART protocol communications to I2C protocol communications or I2C communications to UART protocol. For example, the UART converter 162 may be interconnected with an RS-422 converter 164 or another type of port. The RS-422 may be configured to communicate with an aggregator of information related to the battery assembly (e.g., state of charge, state of health, temperature, operating time, coulomb count).

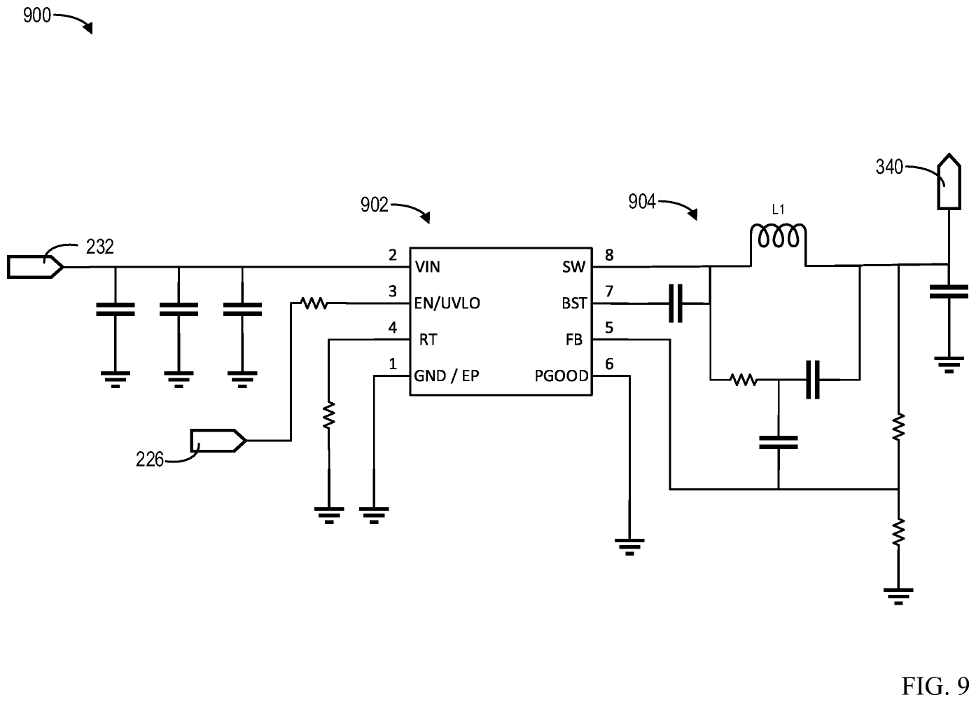

FIG. 9 shows example circuitry 900 in accordance with one or more implementations of the present disclosure. Circuitry 900 may be used to ensure the integrated circuit 104 can change modes regardless of the current state of the integrated circuit. For example, circuitry 900 may receive power from the drain connection 232 of elements 112, 114. As such, circuitry 900 may be energized when the battery assembly 102 has adequate supply. The output may be regulated to around 3 Volts. For example, the circuitry 900 may include a step-down converter 902. The step-down converter 902 may be a fly-buck configuration. For example, the step-down converter 902 may include a field effect transistor. The enable pin of the step-down converter 902 may be energized by the 1.8 Volt regulated voltage 226 or the drain connection 232 of elements 112, 114. An RC network 904 may be used to minimize ripple of the regulated reference voltage 340.

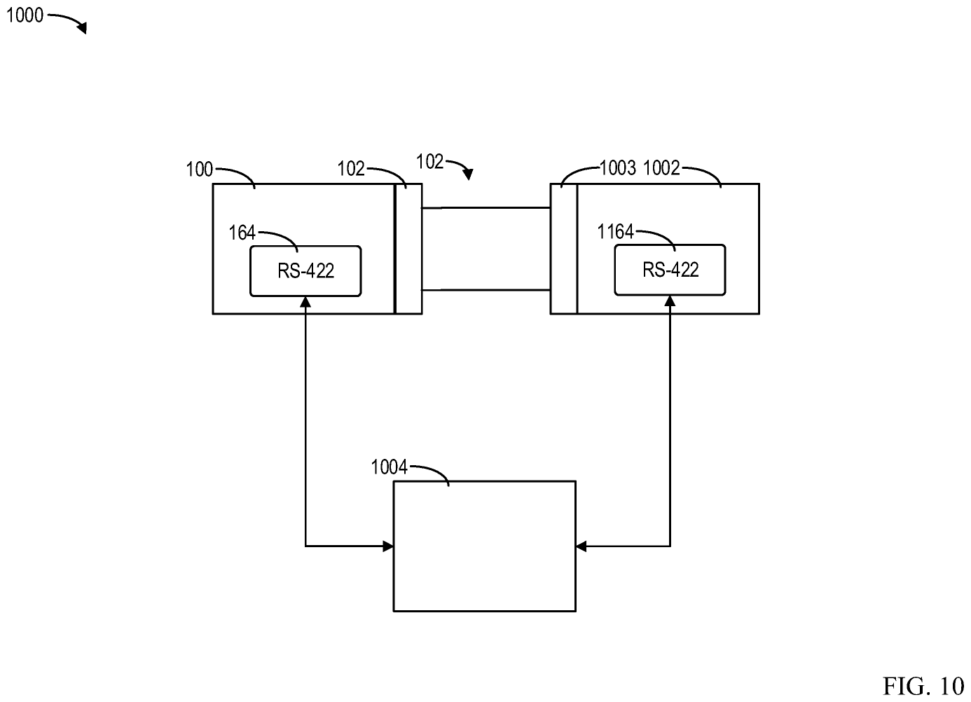

FIG. 10 shows an example battery stack 1000 in accordance with one or more implementations of the present disclosure. The battery stack 1000 may include one or more battery assemblies 102, 1003 and respective battery managers 100, 1002. The battery assemblies 102, 1003 may be arranged in series or parallel. The battery managers 100, 1002 may include the same or similar circuitry and components (e.g., as shown in FIG. 1). For example, the battery managers 100, 1002 may include one or more converters (e.g., converters 162, 164, 1164) configured to provide the stack manager 1004 with battery data. The stack manager 1004 may aggregate the battery data. The battery data may include information determined by the battery managers 100, 1002 (e.g., state of charge, state of health).

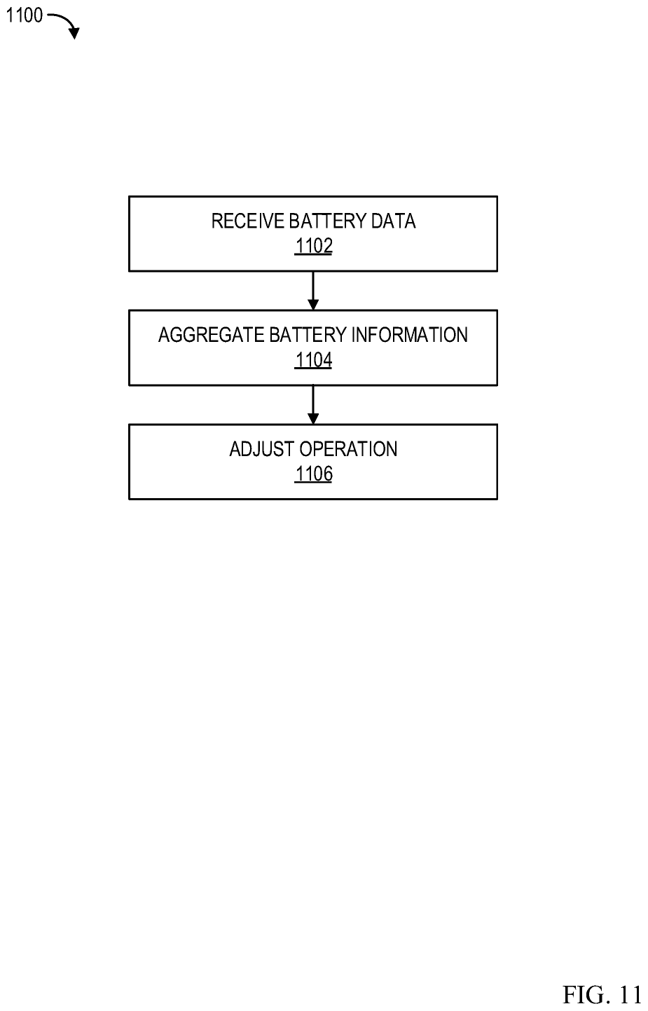

FIG. 11 shows an example method 1100 in accordance with one or more implementations of the present disclosure. The method may be implemented by one or more apparatuses discussed herein (e.g., battery manager 100, stack manager 1004).

In step 1102, first battery data may be received. The first battery data may be indicative of or related to a state of charge, state of health, or other information related to a battery manager (e.g., battery manager 100). The first battery data may be based on a converter (e.g., converter 164). The converter 164 may be configured to convert UART communications to RS-422 communications or protocols. The first battery data may be based on an integrated circuit (e.g., integrated circuit 104).

As an example, second battery data may be received. For example, the second battery data may be indicative of or related to a state of charge, state of health, or other information related to a battery manager (e.g., battery manager 1002). The second battery data may be based on a converter (e.g., converter 1164). The converter 1164 may be configured to convert UART communications to RS-422 communications or protocols. The second battery data may be based on an integrated circuit (e.g., integrated circuit 104). The second battery data may undergo more than one conversion between protocols. For example, the second battery data may be converter from I2C to UART to RS-422.

In step 1104, the first battery data and the second battery data may be aggregated into battery information. For example, the first battery data and the second battery data may be aggregated to determine an overall state of health or individual indications of the state of heath of each of the battery assemblies 102, 1003. The stack manager 1004 may be configured to output indications or statuses of the battery assemblies 102, 1003.

In step 1106, the stack manager 1004 may be configured to send commands or adjust operation of one or more of the battery assemblies 102, 1003 or another implement. For example, the stack manager 1004 may be configured to connect or disconnect a load associated with the battery assemblies 102, 1003 or connect or disconnect a charger associated with the battery assemblies 102, 1003.

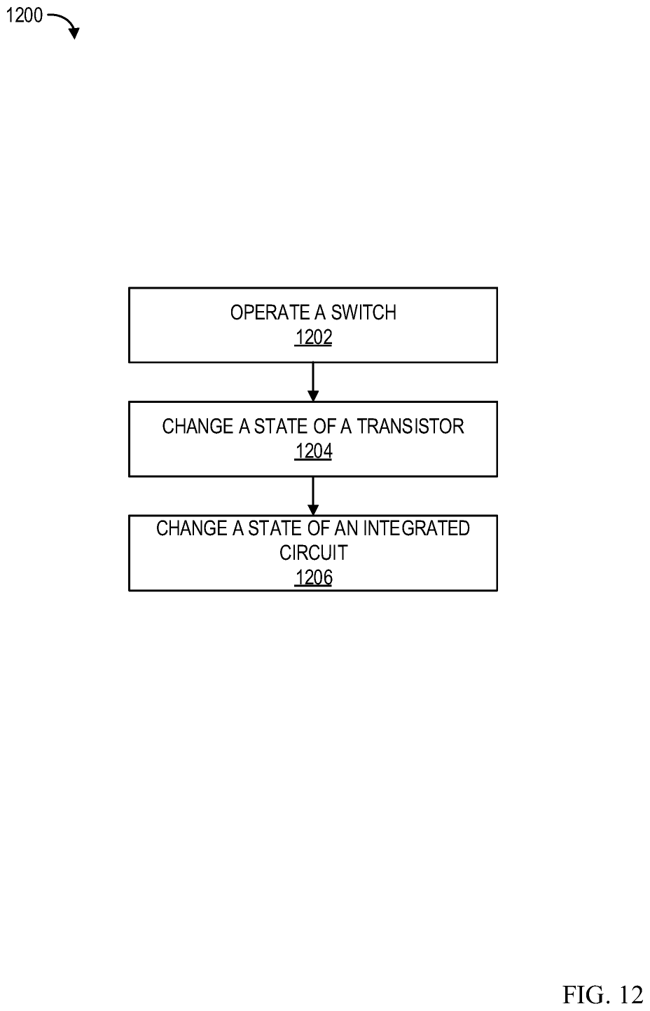

FIG. 12 shows an example method 1200 in accordance with one or more implementations of the present disclosure is shown. In step 1202, a switch (e.g., switch 310) may be operated, or a switch operation may be performed. For example, the operation of the switch may be based on a mechanical interaction or user operation. In step 1204, a transistor may be changed from a first state to a second step. For example, the transistor (e.g., transistor 320) may be configured to impede or conduct from between terminals based on the operation of the switch (e.g., switch 310). In step 1206, an integrated circuit of a battery manager may be changed from a first state to a second state. For example, the integrated circuit (e.g., integrated circuit 104) may be changed from a standby or shutdown mode to a normal operation mode based on the transistor (e.g., transistor 320). For example, the thermistor pin (e.g., pin 210) of the integrated circuit (e.g., integrated circuit 104) may be changed from HIGH to LOW based on the transistor (e.g., transistor 320). The battery manager (e.g., battery manager 100) may be configured to further balance one or more cells of a battery assembly (e.g., battery assembly 102).

While the methods and systems have been described in connection with specific examples, it is not intended that the scope be limited to the particular embodiments set forth, as the embodiments herein are intended in all respects to be illustrative rather than restrictive.

Unless otherwise expressly stated, it is in no way intended that any method set forth herein be construed as requiring that its steps be performed in a specific order. Accordingly, where a method claim does not actually recite an order to be followed by its steps or it is not otherwise specifically stated in the claims or descriptions that the steps are to be limited to a specific order, it is in no way intended that an order be inferred, in any respect. This holds for any possible non-express basis for interpretation, including: matters of logic with respect to arrangement of steps or operational flow; plain meaning derived from grammatical organization or punctuation; the number or type of embodiments described in the specification.

It will be apparent to those skilled in the art that various modifications and variations can be made without departing from the scope or spirit. Other embodiments will be apparent to those skilled in the art from consideration of the specification and practice disclosed herein. It is intended that the specification and examples be considered as exemplary only, with a true scope and spirit being indicated by the following claims.

What is claimed is:

1. A system comprising:
a battery assembly;
a circuit board comprising circuitry, the circuitry comprising a first trace;
an integrated circuit mounted on the circuit board and comprising a thermistor pin, the thermistor pin configured to initiate a first mode of the integrated circuit, wherein the integrated circuit is configured to configured to monitor cells of the battery assembly; and
a first switch mounted on the circuit board, the first switch having a first position and a second position, the first position configured to conduct and the second position configured to impede, the circuitry configured to change a voltage of the thermistor pin based on the first trace according to the first switch.

2. The system of claim 1, wherein the circuitry comprises a second trace and the integrated circuit further comprises a shutdown pin, the shutdown pin configured to initiate a second mode of the integrated circuit, and wherein the first switch is operable to change a voltage of the shutdown pin based on the second trace.

3. The system of claim 2, wherein the integrated circuit is further configured to provide a regulated voltage, the system further comprising:
a transistor having a gate terminal and a source terminal, wherein the first position pulls the gate terminal to ground and the shutdown pin is set based on the regulated voltage and the transistor.

4. The system of claim 3, further comprising:
a resistor disposed between the gate terminal and the source terminal, wherein the resistor has a resistance configured to cause a voltage drop configured to exceed a threshold of the transistor.

5. The system of claim 2, wherein the first position pulls the thermistor pin to ground.

6. The system of claim 2, wherein the second mode consumes less power than the first mode.

7. The system of claim 2, wherein the second mode is a shutdown mode and the first mode is a normal mode.

8. The system of claim 2, wherein the second mode is entered by the integrated circuit based on the first switch being in the first position for more than a duration and the first mode is entered based on the first switch being in the first position for less than the duration.

9. The system of claim 2, wherein the integrated circuit is further configured to provide a regulated voltage, the system further comprising:
a second switch mounted on the circuit board, the second switch disposed between the shutdown pin and the regulated voltage.

10. A system comprising:
a first transistor;
a second transistor;
a circuit board fabricated to form a first planar surface, wherein the circuit board comprises a first trace and a second trace;
an integrated circuit mounted on the circuit board, wherein the integrated circuit is configured to control the first transistor with the first trace and the integrated circuit is configured to control the second transistor with the second trace; and
a first conductor fabricated to form a second planar surface, wherein the second planar surface is offset from the first planar surface and the second planar surface is parallel to the first planar surface, wherein the first conductor is configured to conduct electricity between a first terminal of the first transistor and a second terminal of the second transistor.

11. The system of claim 10, further comprising:
a second conductor in parallel with the first planar surface and the second planar surface, wherein the second conductor is configured to conduct electricity with a battery assembly.

12. The system of claim 11, further comprising:
the battery assembly, wherein the first transistor and the second transistor are positioned between the battery assembly and the circuit board.

13. The system of claim 11, further comprising:
a third conductor in parallel with the first planar surface and the second planar surface, wherein the third conductor is configured to conduct electricity with a battery stack comprising the battery assembly.

14. The system of claim 11, further comprising:
a conductive layer between the second conductor and the circuit board, wherein an area of the conductive layer is equal to an area of a rectangular cross-section of the second conductor.

15. The system of claim 10, further comprising:
a conductive layer between the first conductor and the circuit board, wherein an area of the conductive layer is greater than or equal to an area of a cross-section of the first conductor.

16. The system of claim 10, wherein the first conductor is between the first transistor and the circuit board and the first transistor comprises a gate that is controlled by the first trace.

17. The system of claim 16, further comprising:
a spacer between the first trace and the gate, wherein the spacer comprises a thickness similar to the first conductor such that the first transistor is situated parallel to the first conductor and the circuit board.

18. The system of claim 10, wherein the first conductor comprises a right-angle.

19. The system of claim 10, further comprising:
a fourth conductor comprising a first portion having a thickness substantially similar to a thickness of the first conductor and a second portion having a thickness less than the first conductor and a width less than the first portion.

20. The system of claim 11, further comprising:
a resistor positioned between the battery assembly and the circuit board, wherein a thickness of the resistor is substantially similar to a thickness of the first transistor.
